(19) United States
(12) Patent Application Publication
(10) Pub. No.: US 2008/0001689 A1
(43) Pub. Date: Jan. 3, 2008

(54) Electromagnetic relay

(75) Inventors: Kazuhiro Tsutsui, Iida-shi (JP); Yoshiaki Mimura, Iida-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto-shi (JP)

(21) Appl. No.: 11/804,712

(22) Filed: May 18, 2007

(30) Foreign Application Priority Data
May 19, 2006 (JP) JP2006-139858

(51) Int. Cl. H01H 3/28; H01H 3/00

(52) U.S. Cl. 335/187

(57) ABSTRACT

An electromagnetic relay including a first elastic member for elastically holding an armature at an initial position, an electromagnet portion that exercises magnetic force against the elastic force of the first elastic member under an excitation state to attract the armature to a predetermined excitation position, a movable contact and a fixed contact that come into contact with each other when the armature is moved from the initial position to the excitation position, a movable contact tag to which the movable contact is secured, a second elastic member that exercises predetermined elastic force and holds the movable contact tag at the contact position at which the movable contact and the fixed contact are in contact with each other, and a press portion that moves together with the armature to press the movable contact tag so that the movable contact and the fixed contact are kept in non-contact state with each other.

### BACKGROUND OF THE INVENTION

1. Field of the Invention

The present invention relates to an electromagnetic relay, and particularly an electromagnetic relay that can suppress heating.

2. Description of the Related Art

FIG. 4 shows a diagram showing the structure of a conventional electromagnetic relay (for example, see JP-A-2004-134140). This electromagnetic relay 1 comprises an armature 4 disposed in the neighborhood of an iron core around which a coil 2 is wound, a contact spring 5 which also serves as a passage for load current iz and is secured to the armature 4, a movable contact 6 secured to the tip of the contact spring 5 and a fixed contact 7 disposed so as to face the movable contact 6. In FIG. 4, SW represents an on/off switch for exciting current ir of the coil 2, Vr represents a power source for excitation, Z represents a load and Vz represents a power source for load.

In this construction, the armature 4 is held at a position indicated by a solid line of FIG. 4 (a position spaced from the iron core 3) by the elastic force of the contact spring 5 while SW is set to OFF (i.e., the excitation current ir is equal to zero). Therefore, the movable contact 6 and the fixed contact 7 are kept to be separated from each other (off-state), and the current iz does not flow in the load Z. On the other hand, when SW is set to ON, the armature 4 is attracted to magnetic force occurring in the iron core 3, and displaced to a position indicated by a broken line of FIG. 4. Therefore, the movable contact 6 and the fixed contact 7 are kept in contact with each other (on-state), so that the current iz flows in the load Z through the contact spring 5, the movable contact 6 and the fixed contact 7.

However, the conventional electromagnetic relay 1 has the following problems to be solved.

(1) Heating Problem of the Contacts

When the movable contact 6 and the fixed contact 7 are under the ON-state, the current iz flows along the following route: load Z→contact spring 5→movable contact 6→fixed contact 7→power source Vz for load→load Z. Here, assuming that the resistance component in the route is equal to zero, heating occurring in these passages is also equal to zero. However, actually, the resistance component in the route is not equal to zero, and some amount of resistance component exists in the route. Therefore, when the resistance component concerned is represented by R, power P of iz²R occurs and the heating corresponding to this power P occurs (hereinafter referred to as “contact heat” for convenience).

In order to reduce this contact heat, the resistance component R in the route must be set to be as small as possible. However, the conventional electromagnetic relay 1 has a problem that the resistance component R in the route, particularly the resistance component of the contact spring 5 cannot be reduce to the level as desired. This is because the contact spring 5 has not only a function of serving as a passage for the current iz, but also a function of providing elastic force to the armature 4, and thus the material, the cross-sectional area, etc. of the contact spring 5 cannot be freely selected for the purpose of merely reducing the contact heat.

(2) Problem of Mutual Effect Between Coil Heat and Contact Heat

When the current ir is made to flow into the coil 2, heat occurs in the coil 2 (hereinafter referred to as “coil heat” for convenience), however, the coil heat is transferred to the contact spring 5 through the iron core 3 and the armature 4. At this time, the movable contact 6 and the fixed contact 7 are turned on and the contact heat described above occurs, so that the contact heat and the coil heat have a mutual effect on each other and thus generate high heat.

### SUMMARY OF THE INVENTION

Therefore, the present invention has an object to provide an electromagnetic relay that can avoid the mutual effect problem between coil heat and contact heat with suppressing the contact heat.

In order to attain the above object, an electromagnetic relay according to the present invention comprises: a first elastic member for elastically holding an armature at an initial position; an electromagnet portion that exercises magnetic force against the elastic force of the first elastic member under an excitation state to attract the armature to a predetermined excitation position; a movable contact and a fixed contact that come into contact with each other when the armature is moved from the initial position to the excitation position; a movable contact tag to which the movable contact is secured; a second elastic member that exercises predetermined elastic force and holds the movable contact tag at the contact position at which the movable contact and the fixed contact are in contact with each other; and a press portion that moves together with the armature to press the movable contact tag so that the movable contact and the fixed contact are kept in non-contact with each other.

In the electromagnetic relay described above, it is preferable that the press portion presses the movable contact tag when the electromagnet portion is under the non-excitation state, thereby keeping the movable contact and the fixed contact under the non-contact state, and also the press portion does not press the movable contact tag, but separates from the movable contact tag when the electromagnetic portion is under the excitation state.

The press portion may be integrated with the armature or separated from the armature.

According to the present invention, when the movable contact and the fixed contact come into contact with each other (when the contacts are under ON-state), the load current passes through these contacts and the movable contact tag, however, does not pass through the elastic members (the first elastic member and the second elastic member). Furthermore, the elastic force to the armature is applied by the first elastic member, and the movable contact, the fixed contact and the movable contact tag do not contribute to the application of the elastic force concerned.

Accordingly, the resistance R of the route for the load current can be reduced by reducing the contact resistance and the conductor resistance of the movable contact tag without paying attention to the characteristic of the elastic members (the first elastic member and the second elastic member), so that the contact heat can be greatly suppressed.

In addition, the press portion and the movable contact tag are set to be in non-contact with each other when the electromagnet portion is under the excitation state, whereby the heat of the electromagnet portion (coil heat) can be prevented from being transferred to the movable contact tag, and the mutual effect problem between the coil heat and the contact heat can be avoided.

### BRIEF DESCRIPTION OF THE DRAWINGS

FIGS. 1A and 1B are diagrams showing the principle of an electromagnetic relay 10 according to an embodiment;

FIGS. 2A and 2B are diagrams showing an example of the construction of the electromagnetic relay 10;

FIGS. 3A and 3B are diagrams showing the operation state of the electromagnetic relay 10 of FIGS. 2A and 2B; and

FIG. 4 is a diagram showing the construction of a conventional electromagnetic relay.

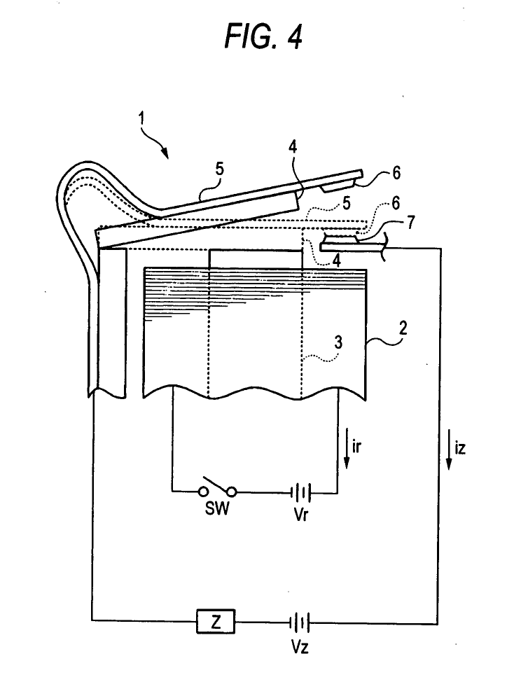

### DETAILED DESCRIPTION OF THE PREFERRED EMBODIMENT

An embodiment of the present invention will be described hereunder with reference to the accompanying drawings. In the following description, specification of various detailed portions, embodiments and examples of numeric values, character arrays and other symbols are used as reference to clarify the technical idea of the present invention, and it is apparent that all or some of these matters does not limit the technical idea of the present invention. Furthermore, with respect to well-known techniques, well-known processing, well-known architectures, well-known circuit constructions, etc. (hereinafter referred to as “well-known matters”), the detailed description thereof is omitted because the description of the present invention is simplified, however, all or some of these well-known matters are not intentionally excluded. These well-known matters may be known by persons skilled in the art at the filing time of this invention, and thus they are contained in the following description.

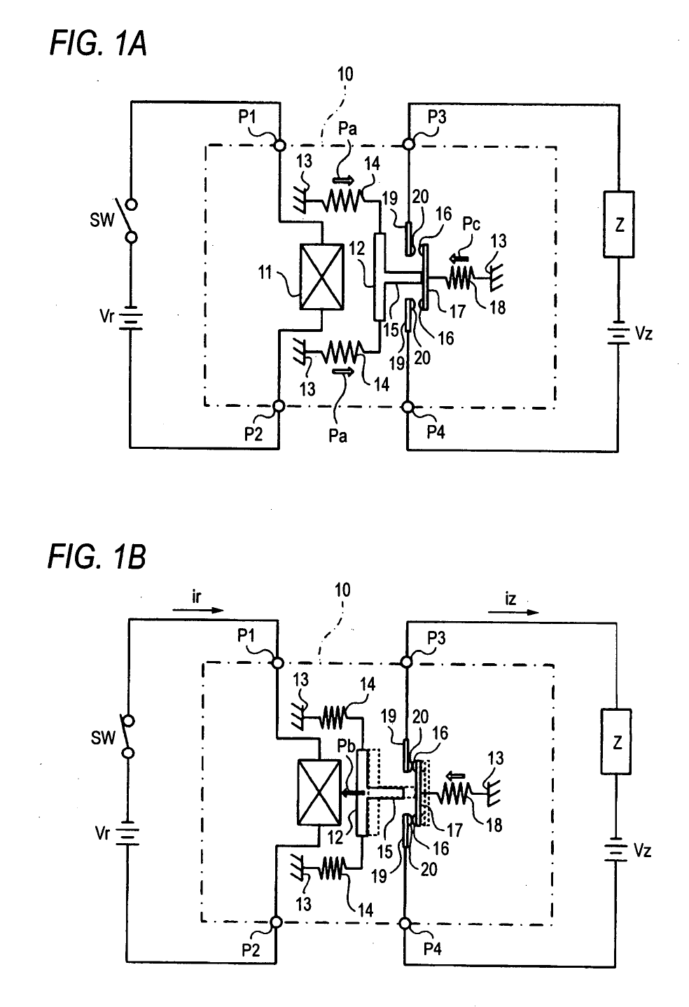

FIGS. 1A and 1B are diagrams showing the principle of an electromagnetic relay 10 according to this embodiment. More specifically, FIG. 1A is a diagram showing a circuit construction under a non-excitation state, and FIG. 1B is a diagram showing a circuit construction under an excitation-state. SW represents an on/off switch of excitation current ir, Vr represents a power source for excitation, Z represents a load, Vz represents a power source for a load, P1, P2 represent coil terminals, and P3, P4 represent fixed contact terminals.

In FIGS. 1A and 1B, the electromagnetic relay 10 contains an electromagnet portion 11 which generates magnetic force when SW is set to ON, and an armature 12 which is separated from the electromagnet portion 11 or approaches to the electromagnet portion 11 in accordance with the excitation/non-excitation of the electromagnet portion 11 is disposed in proximity to the electromagnet portion 11.

Specifically, first elastic members 14 such as springs or the like are disposed between the armature 12 and the relay body 13 while the first elastic members 14 are contracted. The armature 12 is separated from the electromagnet portion 11 by the elastic force Pa of the first elastic members 14 when the electromagnet portion 11 is under the non-excitation state, and also the armature 12 approaches t the electromagnet portion 11 by the suction force Pb of the electromagnet portion 11 (the attraction force caused by the magnetic force of the electromagnet portion 11) which exceeds the elastic force Pa of the first elastic members 14 when the electromagnet portion 11 is under the excitation state.

A press member 15 is secured to the armature 12. In FIGS. 1A and 1B, the armature 12 and the press member 15 are illustrated as being integrated with each other, however, the securing mode is not limited to the above integration mode. For example, the armature 12 and the press member 15 may be designed as separate members. The press member 15 presses a movable contact tag 17 in the rightward direction of FIGS. 1A and 1B when the electromagnet portion 11 is under the non-excitation state , and movables 16 are secured to both the ends of the press member 15. A second elastic member 18 such as a spring or the like is disposed between the movable contact tag 17 and the relay body 13 while the second elastic member 18 is contracted. When the electromagnet portion 11 is under non-excitation state, the press member 15 presses the movable contact tag 17 by the force exceeding the elastic force Pc of the second elastic force 18.

Fixed contacts 20 are secured to fixed contact tags 19 so as to face the movable contacts 16 at both the ends of the movable contact tag 17.

In the construction as described above, as shown in FIG. 1A, when SW is set to OFF so that the electromagnet portion 11 is set to the non-excitation state, the armature 12 undergoes the elastic force Pa of the first elastic members 14 and moves so as to be far away from the electromagnet portion 11, that is, in the rightward direction of FIG. 1A. At this time, the press member 15 secured to the armature 12 presses the movable contact tag 17 in the rightward direction of FIGS. 1A and 1B against the elastic force Pc of the second elastic member 18, whereby the movable contacts 16 and the fixed contacts 20 are set to the non-contact state (off-state).

On the other hand, as shown in FIG. 1B, when SW is set to ON so that the electromagnet portion 11 is set to the excitation state, the armature 12 is moved so as to approach to the electromagnet portion 11, that is, in the leftward direction of FIG. 1B by the attraction force Pb of the electromagnet portion 11. At this time, the elastic member 15 secured to the armature 12 is also moved in the same direction, so that the movable contact tag 17 undergoes the elastic force Pc of the second elastic member 18 and thus moves in the same direction (the leftward direction) and thus the movable contacts 16 and the fixed contacts 20 are set to the contact state (on-state). When the movable contacts 16 and the fixed contacts 20 are in contact with each other as described above, the press member 15 secured to the armature 12 and the movable contact tag 17 are in non-contact with each other.

Here, heating in the electromagnetic relay 10 will be described. As described at the head of the specification, one of heat kinds occurring in the relay is the contact heat. The contact heat occurs in connection with the power P (P=iz²R), and thus both or one of the load current iz and the wire resistance R must be reduced to suppress the contact heat. In this case, the magnitude of the load current iz is determined by the load Z, and thus only the wire resistance R is an adjustable parameter.

Accordingly, the movable contacts 16 and the fixed contacts 20 are required to be formed of materials whose contact resistance is as small as possible, and also the movable contact tag 17 and the fixed contact tags 19 are required to be formed of materials whose conductor resistance and cross-sectional area are as low and large as possible, respectively.

Such a countermeasure (reduction of the wire resistance R) can be easily taken to the electromagnetic relay 10 according to this embodiment. This is because the contact spring 5 serving as the passage of the load current iz is not used unlike the prior art. That is, one function of the contact spring 5 (the route function of the load current iz) is implemented by the movable contact tag 17 itself, and also the other function of the contact spring 5 (the function of applying the elastic force to the armature 4) is implemented by the first elastic members 14 themselves. In short, the two functions of the contact spring 5 are shared and individually implemented by individual parts (the movable contact tag 17 and the first elastic members 14).

Therefore, the selection of the materials of the movable contacts 16 and the fixed contacts 20 and the selection of the materials of the movable contact tag 17 and the fixed contact tags 19 are carried out mainly in consideration of the reduction of the contact resistance and the electrical resistance, and the materials, the cross-sectional area, etc. can be freely set. Therefore, “the problem of contact heat” described at the head of the specification can be easily solved.

Furthermore, in the electromagnetic relay 10 of this embodiment, when the electromagnet portion 11 is set to the excitation state, the armature 12 and the movable contact tag 17 are set to the non-contact state, so that the heat occurring in the electromagnet portion 11 (coil heat) is not transferred to the movable contact tag 17. Accordingly, “the problem of mutual effect between coil heat and contact heat” described at the head of the specification can be solved.

The electromagnetic relay that can suppress the contact heat and avoid the problem of the mutual effect between the coil heat and the contact heat can be provided by the principle construction described above. Any construction can be adopted for the electromagnetic relay 10 insofar as the above principle construction is adopted.

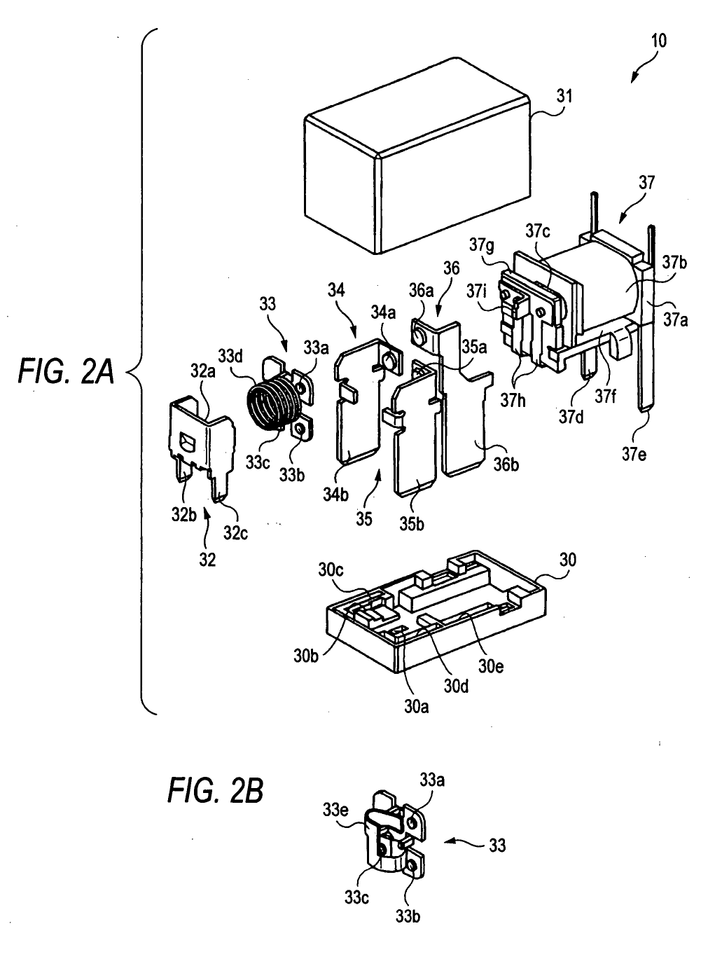

FIG. 2A shows an example of the specific construction of the electromagnetic relay 10. In FIG. 2A, the electromagnetic relay 10 has a base 30 formed of an insulating member, and a box-shaped case 31 whose bottom surface is opened. A stopper 32, a movable contact tag 33 (corresponding to the movable contact tag 17 of FIG. 1), fixed contact tags 34 to 36 (corresponding to the movable contact tags 19 of FIGS. 1A and 1B) and an electromagnet portion 37 (corresponding to the electromagnet portion 11 of FIGS. 1A and 1B) are secured to the base 30, and it is covered by the case 31 from the upper side, thereby fabricating the electromagnetic relay 10.

The stopper 32 is constructed by bending a metal plate in U-shape so that a recess portion 32a and two leg portions 32b and 32c are formed, and it is fixed to the base 30 by fitting the leg portions 32b and 32c into holes 30a and 30b of the base 30.

The movable contact tag 33 is constructed by forming movable contacts 33a to 33c (in this case, three movable contacts are provided, however, the number of the movable contacts is not limited to three) (corresponding to the movable contacts 16 of FIGS. 1A and 1B) at the corner portions of a substantially rectangular metal plate having low conductor resistance, and further fixing one end of a spring 33d (corresponding to the second elastic member 18 of FIGS. 1A and 1B) to the metal plate. The other end of the spring 33d is fitted to the recess portion 32a of the stopper 32.

In the case of FIG. 2A, the fixed contact tags 34 to 36 comprise three fixed contact terminals 34 to 36 ((corresponding to the fixed contacts 20 of FIGS. 1A and 1B), all the fixed contact tags are formed of metal material having low conductor resistance so as to have a predetermined shape. Leg portions 34b to 36b are provided to the fixed contact tags 34 to 36 respectively, and these leg portions 34b to 36b are fitted in holes 30c to 30e of the base 30, thereby fixing the fixed contact tags 34 to 36 to the base 30.

The electromagnet portion 37 is equipped with a spool 37a, a coil 37b wound around the spool 37a, an iron core 37c, coil terminals 37d, 37e connected to both the coil 37b, a yoke 37f, an armature 37g (corresponding to the armature 12 of FIGS. 1A and 1B), hinge springs 37h (corresponding to the first elastic members 14 of FIGS. 1A and 1B) and a press member 37i (corresponding to the press member 15 of FIGS. 1A and 1B).

The armature 37g is separated from the iron core 37c by the elastic force of the hinge spring 37h when the coil 37b is under non-excitation, and thus when the coil 37b is set to an excitation state, it is attracted to the iron core 37c against the elastic force of the hinge spring 37h.

The press member 37i is secured to the armature 37g. When the coil 37b is under the non-excitation state, the press member 37i presses the movable contact tag 33 so that the movable contact tag 33 approaches to a stopper 32, thereby keeping the movable contacts 33a to 33c and the fixed contacts 34a to 36a under the non-contact state (off-state). On the other hand, when the coil 37b is under the excitation state, the press member 37i does not press the movable contact tag 33, and keeps the movable contacts 33a to 33c and the fixed contacts 34a to 36a under the contact state (on-state). In FIG. 2A, the armature 37g and the press member 37i are illustrated as being separated from each other, however, the construction of these elements is not limited to this separate construction. They may be designed to be integrated with each other (integral construction).

FIG. 2B is a diagram showing another example of the elastic member secured to the movable contact tag 33. In place of the spring 33d of FIG. 2A, a leaf spring 33e (corresponding to the second elastic member 18 of FIGS. 1A and 1B) is used.

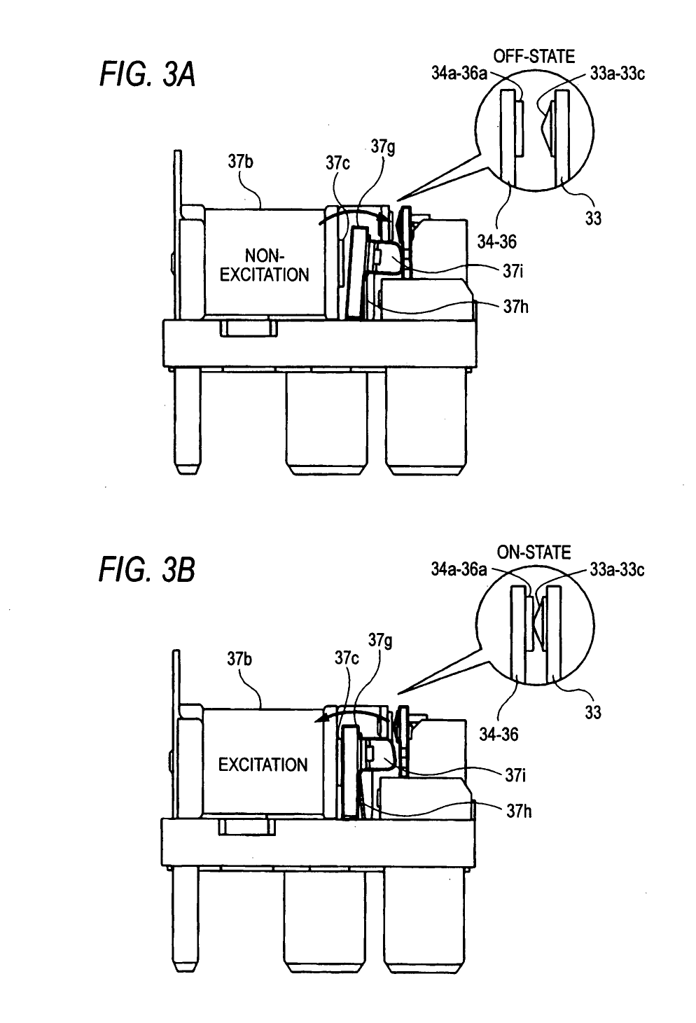

FIGS. 3A and 3B are diagrams showing the operation state of the electromagnetic relay 10 of FIG. 2, wherein FIG. 3A is a diagram showing the electromagnetic relay 10 under the non-excitation state, and FIG. 3B is a diagram showing the electromagnetic relay 10 under the excitation state.

First, as shown in FIG. 3A, when the coil 37b is set to the non-excitation state, the armature 37g is displaced so as to be far away from the iron core 37c by the elastic force of the hinge spring 37h, and in connection with this displacement, the movable contact tag 33 is pressed to the right side of FIG. 3A by the press member 37i secured to the armature 37g. Accordingly, under the non-excitation state, the fixed contacts 34a to 36a of the fixed contact tags 34 to 36 and the movable contacts 33a to 33c of the movable contact tag 33 are kept under the non-contact state (off-state).

On the other hand, as shown in FIG. 3B, when the current is made to flow into the coil 37b to set the coil 37b to the excitation state, the armature 37g is attracted by the magnetic force occurring in the iron core 37c and thus displacement so as to approach to the iron core 37c. At this time, the press member 37i secured to the armature 37g is also displaced in the same direction by the same displacement amount, and thus the movable contact tag 33 is kept free, so that the movable contact tag 33 moves to the left side of FIG. 3B by the elastic force of the spring 33d (or the leaf spring 33e). Therefore, the fixed contacts 34a to 36a of the fixed contact tags 34 to 36 and the movable contacts 33a to 33c of the movable contact tag 33 are kept under the contact state (on-state).

In the construction described above, load current (corresponding to the load current iz of FIGS. 1A and 1B) passes through only the fixed contact tags 34 to 36, the fixed contacts 34a to 36a, the movable contacts 33a to 33c and the movable contact tag 33, and it does not pass through the spring 33d (or the leaf spring 33e). In other words, the spring 33d (or the leaf spring 33e) mostly contributes to the movement of the movable contact tag 33, and it never contributes to the route of the load current iz.

Therefore, the contact heat can be suppressed by merely using materials having low conductor resistance for the fixed contact tags 34 to 36 and the movable contact tag 33, increasing the cross-sectional area of these tags, and using materials having low conductor resistance for the fixed contacts 34a to 36a and the movable contacts 33a to 33c, whereby the resistance R of the route for the load current can be reduced to the minimum level. Accordingly, it is never required to pay attention to the characteristic of the spring 33d (or the leaf spring 33e) when some countermeasure is taken to reduce the resistance R of the route. Therefore, “the problem of contact heat” described at the head of the specification can be easily solved.

In addition, when the electromagnet portion 37 is set to the excitation state, the armature 37c and the movable contact tag 33 are kept under the non-contact state, and thus heat occurring in the electromagnet portion 37 (coil heat) is not transferred to the movable contact tag 33. Accordingly, “the problem of mutual effect between the coil heat and the contact heat” described at the head of the specification can be also solved.

As described above, the electromagnetic relay that can suppress the contact heat and avoid the mutual effect problem between the coil heat and the contact heat can be provided by constructing the electromagnetic relay 10 shown in FIG. 2.

In the specific construction (FIG. 2) described above, the number of the movable contacts 33a to 33c and the number of the fixed contacts 34a to 36a are respectively set to three, and in the principle construction (FIG. 1) described above, the number of the movable contacts 16 and the number of the fixed contacts 20 are respectively set to two. However, these numbers of the movable and fixed contacts are merely set as examples for convenience of description. These numbers of the contacts are not limited to specific values insofar as they are normally open type contacts.

What is claimed is:

1. An electromagnetic relay comprising:
a first elastic member for elastically holding an armature at an initial position;
an electromagnet portion that exercises magnetic force against the elastic force of the first elastic member under an excitation state to attract the armature to a predetermined excitation position;
a movable contact and a fixed contact that come into contact with each other when the armature is moved from the initial position to the excitation position;
a movable contact tag to which the movable contact is secured;
a second elastic member that exercises predetermined elastic force and holds the movable contact tag at the contact position at which the movable contact and the fixed contact are in contact with each other; and
a press portion that moves together with the armature to press the movable contact tag so that the movable contact and the fixed contact are kept in non-contact state with each other.

2. The electromagnetic relay according to claim 1, wherein the press portion presses the movable contact tag when the electromagnet portion is under the non-excitation state, thereby keeping the movable contact and the fixed contact under the non-contact state, and also the press portion does not press the movable contact tag, but separates from the movable contact tag when the electromagnetic portion is under the excitation state.
